(19) United States
(12) Patent Application Publication
(10) Pub. No.: US 2005/0257205 A1
(43) Pub. Date: Nov. 17, 2005

(54) Method and system for dynamic software updates

(75) Inventors: Mihai Costea, Redmond, WA (US); Manojkumar H. Shende, Redmond, WA (US); Thomas D. McGuire, Georgetown, TX (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/845,300

(22) Filed: May 13, 2004

(51) Int. Cl. G06F 9/44

(52) U.S. Cl. 717/168

(57) ABSTRACT

A system and method for dynamically updating digital information, such as a data file, between computing devices in a computer network are provided. The digital information identifier, such as a file name, and a unit identifier, such as a size, of the digital information are provided by a publishing computing device. The publishing computing device receives a request for a delta portion of the identified digital information and, in response to the request, dynamically generates a patch including a copy of the requested information. Once the patch is generated, publishing computing device provides the patch to the party requesting the information.

### FIELD OF THE INVENTION

In general, the present invention relates to networked computers and computer software and, in particular, to a system and method for dynamically maintaining and updating computer software stored on networked computers.

### BACKGROUND OF THE INVENTION

Currently, computer software is regarded as discrete versions being updated only occasionally. Typically, software is updated by the use of discrete patches, which either replace old versions of the computer software with newer versions or incorporate the difference included in the discrete patch into the existing version. Discrete patches are specifically designed to update a specific version of a computer program to a current version.

Historically, discrete patches were obtained in physical form (e.g., on a 3.5″ diskette, or Compact Disk) as an update to an existing program. For example, a user who owned a copy of Windows® 2000, published by Microsoft®, a discrete version of software, may obtain a discrete update (or service pack) on a Compact Disk, that would be used to update the computer software. For example, the discrete update may improve the reliability and security of Windows® 2000.

More recently, with the increased usage of networked computers, increased bandwidth and speed of communication mediums, and increased use of the Internet, discrete patches are now available online and are much more accessible to end users. For example, a user may access a server containing discrete updates and download an appropriate update directly to the user's computer. However, as with the historical technique, the patches remain discrete—each patch is predesigned to update a specific known version of a program to a specific point or new version.

FIG. 1 is a block diagram of a computer network 100 containing five computers 101, 103, 105, 107, 109 in communication via a network 111. The computer network 100 illustrates one existing technique for providing discrete computer software patches 115, 117, 119 via the network 111 to any one of a group of client computers 103, 105, 107, 109. Typically, a publishing computer 101 contains a current version of computer software 113—in this example, version 3.0 and a series of discrete patches 115, 117, 119—that may be provided to client computers 103, 105, 107, 109 to facilitate updates of older versions of computer software 113. Client computers 103, 105, 107, 109 each contain different versions 103A, 105A, 107A of computer software 113.

FIG. 2 is a flow diagram illustrative of a typical process 200 for updating older versions 103A, 105A, 107A of computer software 113 that reside on client computers 103, 105, 107, 109. As illustrated at block 201, publishing (server) computer 101 publishes a current file name and a “hash value” for the computer software 113. A “hash value”—also known as a message digest—is a number generated from data that is used to represent that data. The formula used to generate the hash value is such that it generates a hash value that is unique to that data. In this example, each version of the computer software 103A, 105A, 107A, 109A, 113 (FIG. 1) would have a unique hash value, with the exception of 109A and 113, because both represent the same version of computer software 113 (version 3.0).

The published information is available via network 111 for download by client computers 103, 105, 107, 109. At block 203, a client computer downloads the current file name and hash value provided by the publishing computer 101 and determines, at decision block 205, whether its local file has the same hash value as the hash value published at block 201. If the client computer determines at block 205 that its local file has the same hash value as the published hash, the process 200 completes, as illustrated by block 207. Matching hash values indicates to the client computer that it has a current version of the computer software 113.

Returning to decision block 205, if the client computer determines that its local file does not have the same hash value as the published hash value, the client computer, via network 111, uploads its local hash value to the publishing computer 101, as illustrated by block 209. Publishing computer 101, upon receipt of an uploaded local hash value from a client computer, at block 211, determines what version of computer software 113 is currently residing on the client computer. This determination is accomplished by referring to the local hash value that has been uploaded by the client computer and comparing it to a list of hash values and corresponding versions maintained by the publishing computer 101. For example, if client computer 103 uploaded a hash value for file version 1.0 103A, it would be the same hash value for any client computer containing file version 1.0. However, if a client computer, such as client computer 105, uploaded a hash value for file version 1.1 105A, it would be a different hash value than the hash value for file version 1.0 103A. Thus, the publishing computer 101 can determine based on the uploaded local hash value what version of the computer software is currently resident on a client computer.

Once publishing computer 101, at block 211, has determined what version of computer software 113 is present on the client computer, publishing computer 101 identifies the appropriate discrete patch 115, 117, 119 needed to update the client computer, and publishes that discrete patch 115, 117, 119, as illustrated by block 213, for download. For example, if client computer 103 had uploaded a hash value identifying that it currently had file version 1.0 103A, the publishing computer 101 would properly identify discrete patch 115. Discrete patch 115 includes information necessary to update file version 1.0 103A to the current file version 3.0 113.

Continuing with the example of updating client computer 103, at block 215 client computer 103 downloads discrete patch 115. At block 217, client computer 103 applies the discrete patch 115 to local version 1.0 103A, thereby updating local version 1.0 103A to match current version 113. Upon applying discrete patch 115 and updating the version 103A contained on local computer 103, the process completes, as illustrated by block 207.

While the technique illustrated in FIG. 2 provides advantages over the historical physical update techniques, it remains limited to discrete patches. Regarding software and patches as being discrete works for a limited number of updates, but becomes unmanageable as the number of updates increases, because a publishing computer is required to maintain an individual discrete patch for each possible update. Additionally, as the number of updates increases, the publishing computer must likewise increase its ability to respond to uploaded hash values, identify the software version, and provide a patch for that particular version. One example of discrete patches becoming unmanageable is in the ongoing battle against computer viruses. For an antivirus program to adequately protect a computer from virus attacks it needs to maintain an up-to-date list of virus signatures. Thus, each time a virus is identified and a signature defined, an update needs to be provided to the antivirus program. Maintaining a discrete patch for every potential combination of a client antivirus program and a current vision could easily grow into the hundreds or thousands of discrete patches in a short period of time.

FIG. 3 is a block diagram of a computer network 300 including two computers 301, 303 in communication via a network 311. FIG. 3 illustrates an example of a technique typically used in an effort to resolve the problem of unmanageable discrete patches resulting from frequent computer virus signature updates.

A publishing computer 301 maintains a main file 313 containing a list of computer virus signatures and a daily file 315, also containing a list of computer virus signatures. The daily file 315 is updated with new virus signatures as new computer viruses are discovered and defined, while the main file 313 remains the same. As a result, the daily file 315 continues to grow as updates occur. When the daily file 315 reaches a predetermined size, all the virus signatures in the daily file 315 are appended to the main file 313. The main file 313 becomes a new main file 313. The daily file 315, after the information contained in it has been appended to the main file 313, is cleared and the process repeats.

For explanation purposes of the above technique, a five day example is provided. On Day 1, the daily file 315 contains one virus signature, and the main file 313 contains four hundred virus signatures. On Day 2, the main file 313 remains the same at four hundred virus signatures, while ten new virus signatures are added to the daily file 315. On Day 3, the main file 313 remains the same at four hundred virus signatures, and twelve new virus signatures are added to the daily file 315. On Day 4, the main file 313 again remains the same at four hundred virus signatures, while five new virus signatures are added to the daily file 315. Thus, at the end of Day 4, the main file 313 remains unchanged from Day 1, still containing four hundred virus signatures, while the daily file 315 has grown from one virus signature to twenty-eight virus signatures. Assuming the predetermined size for the daily file 315 is reached at the end of Day 4, the twenty-eight virus signatures residing in the daily file 315 are appended to the main file 313 and the daily file 315 is cleared. At the beginning of Day 5, the main file 313 contains four hundred twenty-eight virus signatures and the daily file 315 contains zero virus signatures.

With continuing reference to FIG. 3, a client computer 303 includes a local main file 317 and a local daily file 319, both of which are updated to reflect the information contained in the main file 313 and the daily file 315, respectively. The update is accomplished via the network 311. As will be described with reference to FIG. 4, a complete copy of the main file 313 or the daily file 315 is downloaded by the client computer 303 every time there is a change to one of the files. Thus, referring back to our five-day example, assuming the client computer 303 checks for changes on a daily basis, a complete copy of the daily file 315 is downloaded by client computer 303 each day and a complete copy of the main file 313 is downloaded at Day 5.

FIG. 4 illustrates a process 400 implemented by a computer network 300 for updating a local main file 317 and a local daily file 319. In particular, the publishing computer 301, at block 401, publishes a main file name and a hash value for the main file 313. The published main file name and hash value are available via the network 311 to other computers, such as client computer 303. The client computer 303, wanting to update its virus signature file, which is local main file 317, and local daily file 319, at block 403 downloads the published main file name and hash value. At decision block 405, the client computer 303 determines whether the local main file 317 has the same hash value as the hash value downloaded at block 403. If the local hash value does not match the published hash value, at block 407 the client computer 303 requests a copy of the main file 313, and the local main file 317 is replaced with the downloaded copy of the main file 313. After a copy of main file 313 has been downloaded at block 407, or if it is determined at decision block 405 that the hash value of the local main file 317 matches the hash value downloaded at block 403, at block 409 the client computer 303 downloads a copy of the master daily file 315 and replaces the currently existing local daily file 319. As indicated above, a complete copy of the daily file 315 is downloaded for each instance of process 400. Once the daily file 315 has been downloaded and the local daily file 315 is replaced, the process completes, as illustrated at block 411.

While the update process illustrated in FIG. 4 resolves the problem of maintaining multiple discrete patches as described with respect to FIGS. 1 and 2, it requires that a client computer, such as computer 303, download the same information more than once. In particular, as described with respect to FIG. 4, local computer 303 downloads and replaces the daily file 315 each time the software update routine 400 occurs. Referring back to the five-day example, local computer 303 downloads the daily file 315 on Day 1, Day 2, Day 3, Day 4, and again on Day 5. Thus, each time local computer 303 downloads a copy of the daily file 315, it downloads several virus signatures for which it already previously had a copy. Additionally, on Day 5, local computer 303 downloads an entirely new copy of the main file 313. Depending on the network connection and the size of the main file 313, this download can take a substantial length of time to accomplish, thereby frustrating an end user.

Based on the above-mentioned deficiencies associated with existing software update techniques, and in particular, virus signatures update techniques, there is a need for a system and method that updates computer software and other digital information, such as virus signatures, in an efficient manner that minimizes the burden on both the publishing computing device and the client computing device.

### SUMMARY OF THE INVENTION

A system and method for dynamically updating digital information, such as a data file, between computing devices in a computer network are provided. A data file identifier, such as a file name, and a unit identifier, such as the size of the data file, are provided by a publishing computing device. The publishing computing device receives a request for a delta portion of the data file and, in response to the request, dynamically generates a patch including a copy of the requested delta portion of the data file. Once the patch is generated, the publishing computing device provides the patch to the requesting party.

In accordance with an aspect of the present invention, a method for updating a local data file is provided. In accordance with the method, a local computing device containing the local data file obtains a data file identifier identifying a master data file. The local computing device also obtains a unit identifier representative of a master data file. After obtaining the identifiers, the local computing device determines a delta between the master data file and the local data file and obtains a patch containing a copy of a delta portion of the master data file. Finally, after obtaining the patch, the local computing device updates the local data file with the patch.

In accordance with another aspect of the present invention, a method of providing data file updates to at least one computing device in communication, via a network, with another computing device is provided. In accordance with the method, a data file identifier and size is published on the network. A request is received from a source for a portion of the identified data file. Upon receipt of the request, a determination is made as to whether the source is authorized to receive the requested portion of the data file. After authentication, a data file update that is representative of the requested portion of the data file is generated and provided to the source.

In accordance with a further aspect of the present invention, a computer system having a computer-readable medium having a computer-executable program therein for performing the method of validating a local data file and updating the local data file is provided. In accordance with the method, the computer system receives a first transmission of information, the first transmission of information including a name for a master data file, a size of the master data file, and a digital signature. The computer system validates the local data file with the received digital signature and determines the difference in the size of the local data file and the size of the master data file. Once the difference is determined, the computer system requests a portion of the master data file representative of the difference in the size. In response to the request, the computer system receives a second transmission of information that includes the requested portion of the master data file and regenerates the local data file in response to the received second transmission.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a computer network containing five computers in communication with one another via a network for providing discrete computer software updates;

FIG. 2 is a flow diagram illustrative of a typical process of updating computer software using discrete patches for the computer network illustrated in FIG. 1;

FIG. 3 is a block diagram illustrative of a computer network, including two computers communicating with one another through a network interface for providing discrete updates for computer software;

FIG. 4 is a flow diagram illustrative of a typical overall process for providing discrete computer software updates to a computer located on the computer network illustrated in FIG. 3;

FIG. 5 is a block diagram illustrative of a computing device network, including four computing devices in communication with one another through a communication network for implementing embodiments of the present invention;

FIGS. 6A-6C are block diagrams illustrative of a computing device network including three computing devices in communication through a network for implementing embodiments of the present invention;

FIG. 7 is a flow diagram illustrative of the overall process of updating computer software on a local computing device implemented on a computer network, such as the computing device network illustrated in FIGS. 6A-6C, in accordance with an embodiment of the present invention;

FIG. 8 is a flow diagram illustrative of a publish computer software update routine implemented by a networked computing device, such as the computing devices illustrated in FIGS. 6A-6C, in accordance with an embodiment of the present invention; and

FIG. 9 is a flow diagram illustrative of a receive computer software update routine implemented by a networked computing device, such as the computing devices illustrated in FIGS. 6A-6C, in accordance with an embodiment of the present invention.

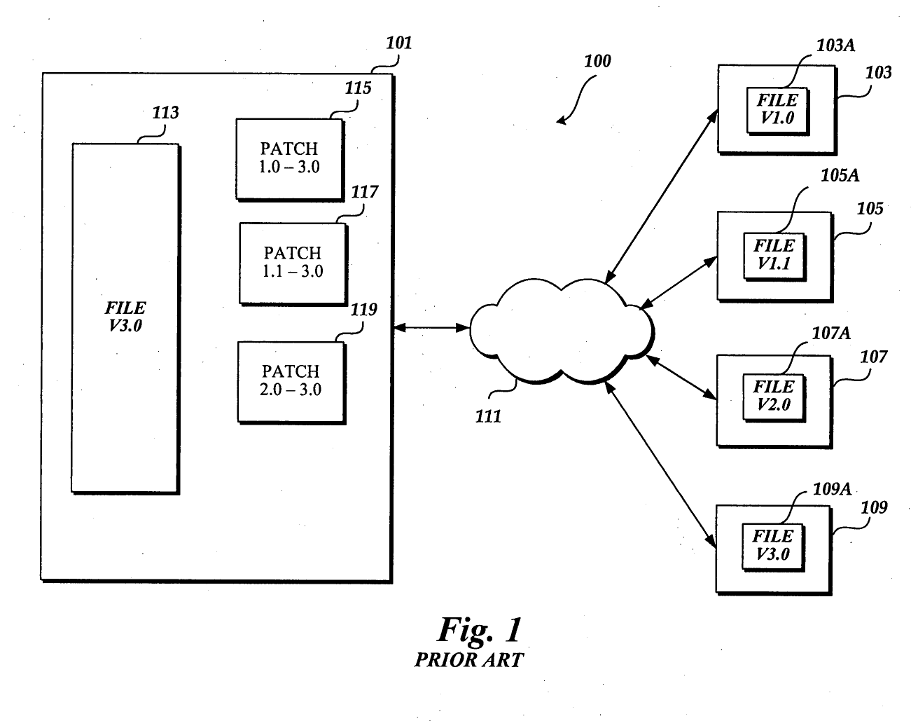

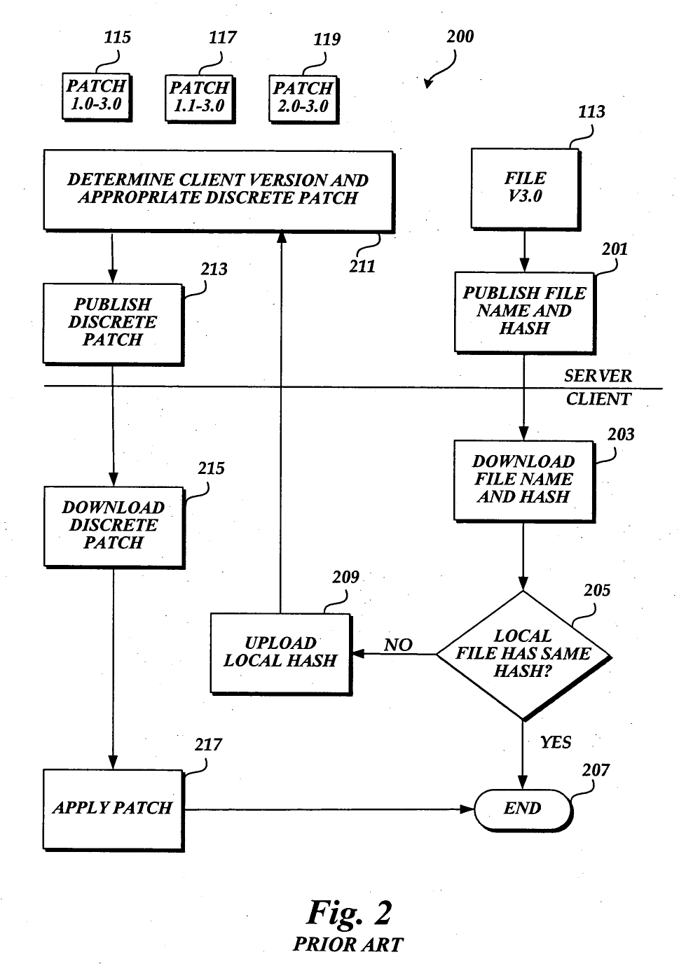

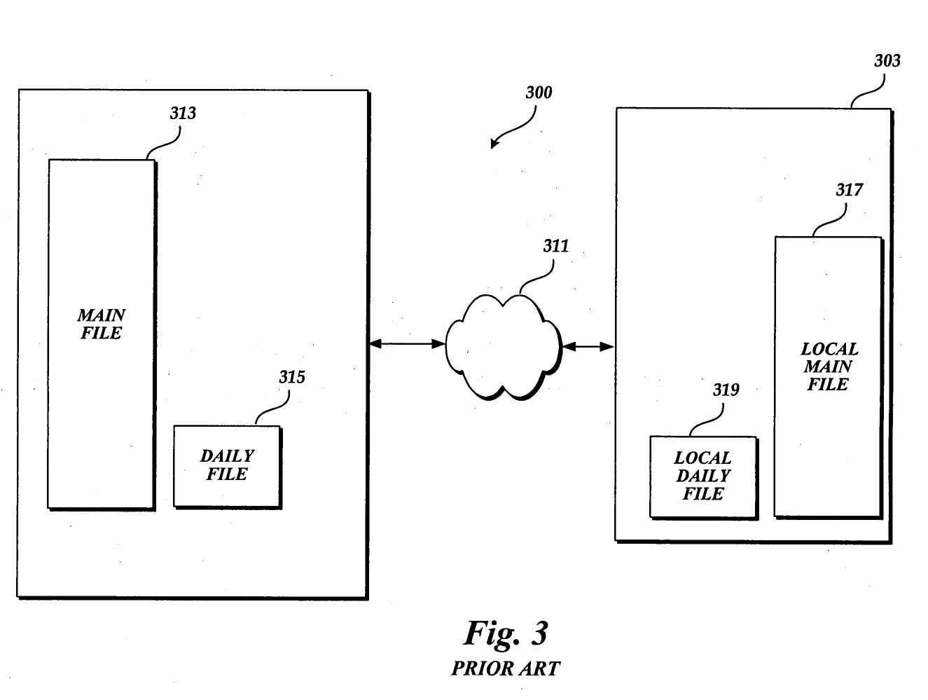

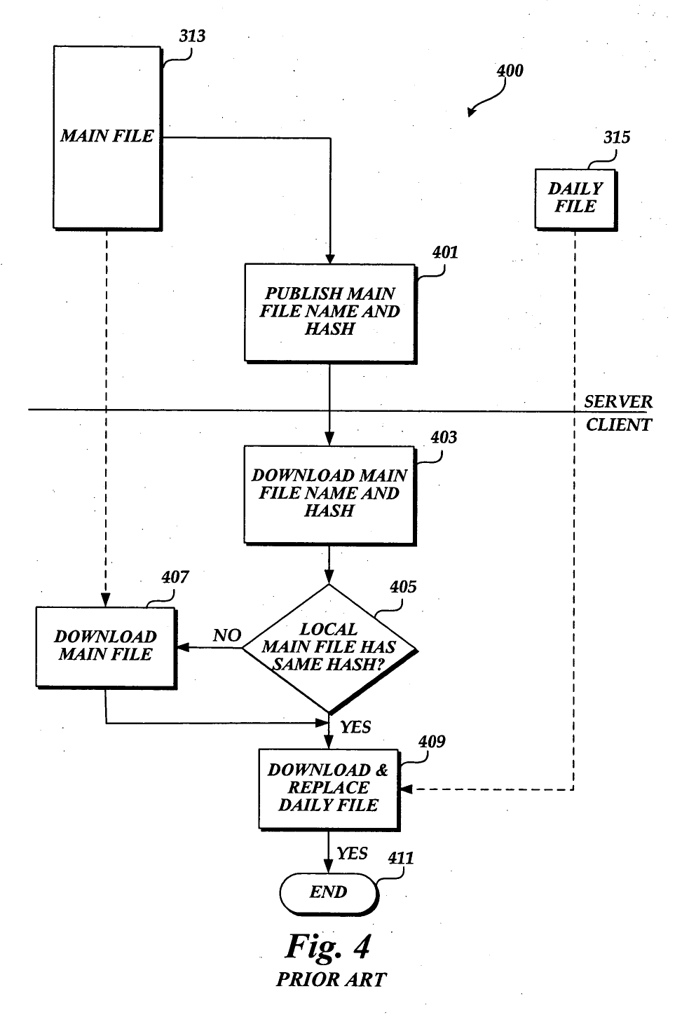

### DETAILED DESCRIPTION OF THE PREFERRED EMBODIMENT

Generally described, embodiments of the present invention regard computer software and updates as a continuously evolving entity. More specifically, the present invention corresponds to a system and method for updating a “data file” located on a client computing device to match a master data file contained on a publishing computing device. A “data file” as used herein is any collection of digital information that may be modified or altered over time by the inclusion of additional digital information. For example, a data file may be, but is not limited to, a collection of virus signatures, a collection of spam rules, a collection of personal contacts, a collection of digital documents, a collection of advertisement blocking rules, etc. The data file is updated by allowing a client computing device to determine the differences between a master data file and its local data file, and having a publishing computing device dynamically generate an appropriate patch that is downloaded and applied by the client computing device.

Embodiments of the present invention allow a publishing computing device to maintain a limited number of master data files and limits the amount of load required by a publishing computing device for determining what portion of a master data file is to be provided to a client computing device requesting an update. Additionally, embodiments of the present invention reduce the client side burden by only requiring that a client computing device download a particular portion of a master data file or digital information a limited number of times. Minimizing client side burden improves customer satisfaction with computer updates, increases stability of the computing platform, and increases the overall ease of use of computing devices by an end user.

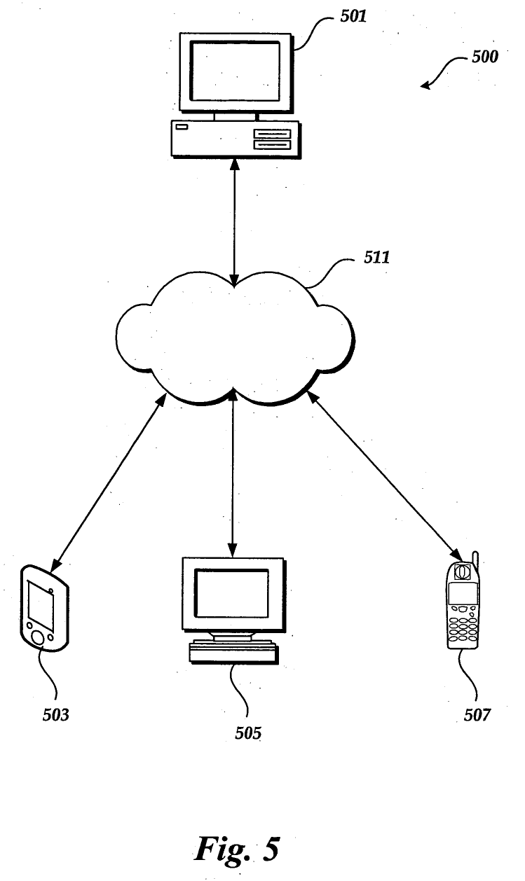

Although the present invention will be described with regard to a computing device network utilizing a server as a publishing computing device publishing dynamic updates, and client computing devices as the computing devices receiving the updates, those skilled in the relevant art will appreciate that the present invention may be implemented in any variety of computing devices. For example, the publishing computing device may include multiple servers, and the client computing device may be an administrator of multiple client computing devices, other servers, etc. As illustrated with reference to FIG. 5, computing devices may be any type of computing device. Additionally, while the discussion provided herein describes the dynamic update of a data file for ease of description, it will be understood that embodiments of the present invention may be utilized to dynamically update any form or type of digital information that may be stored on a computing device. For example, embodiments of the present invention may be utilized to dynamically update computer software, etc. Finally, as will be described with respect to embodiments of the present invention, the updates transmitted from a publishing computing device to a client computing device may be transmitted uncompressed and/or may be compressed using any type of compression technique. Accordingly, the embodiments described with regard to the present invention should be construed as illustrative in nature and not as limiting.

FIG. 5 illustrates a computer network 500 having four computing devices 501, 503, 505, 507. Computing devices 501, 503, 505, 507 may be embodied as any one of a variety of computing devices that are capable of interacting with other computing devices through a network 511. Examples of computing devices 501, 503, 505, 507 include, but are not limited to, personal computing devices, handheld computing devices, server-based computing devices, personal digital assistants (PDAs), mobile telephones, stand-alone memory devices, electronic devices having some type of memory, whether external or internal, removable or permanent, and the like. As will be appreciated by those skilled in the art, there is an ever-increasing vast majority of different computing devices that are capable of interfacing with one another via networks, such as the network 511, as illustrated in FIG. 5. As will be described herein, any type of computing device, such as computing devices 501, 503, 505, 507 that is capable of communicating through a network 511 to implement a computer network 500 may be utilized for practicing embodiments of the present invention.

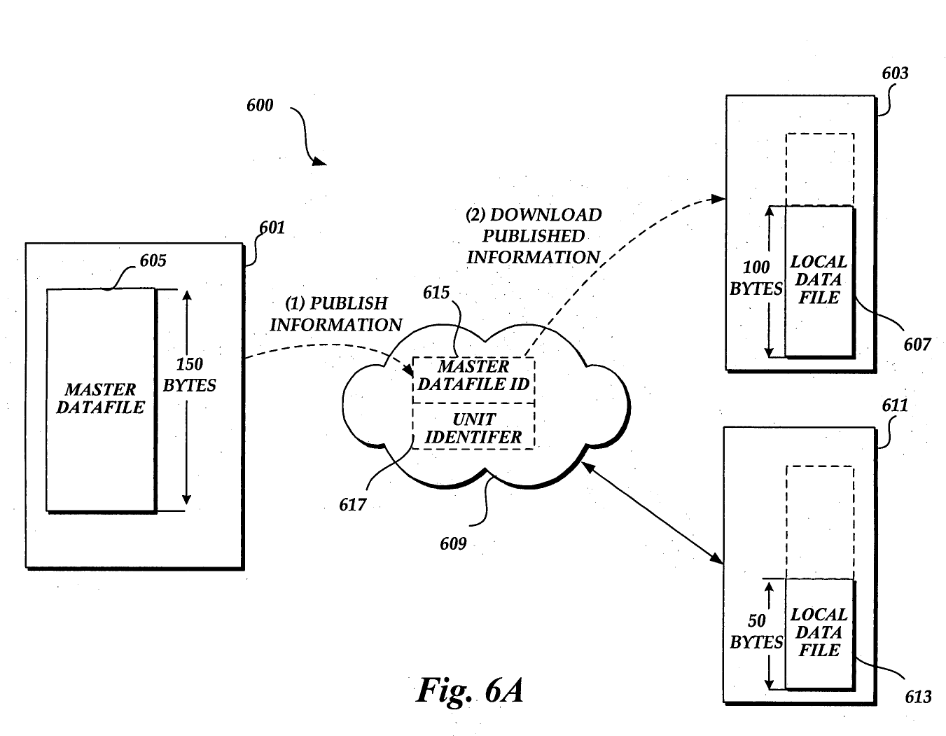

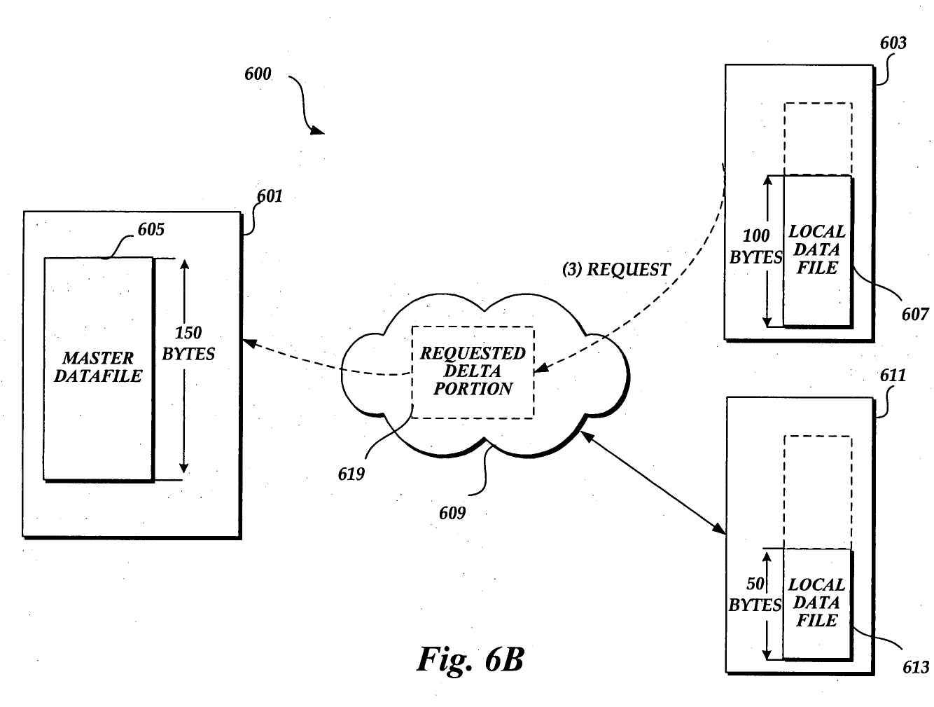

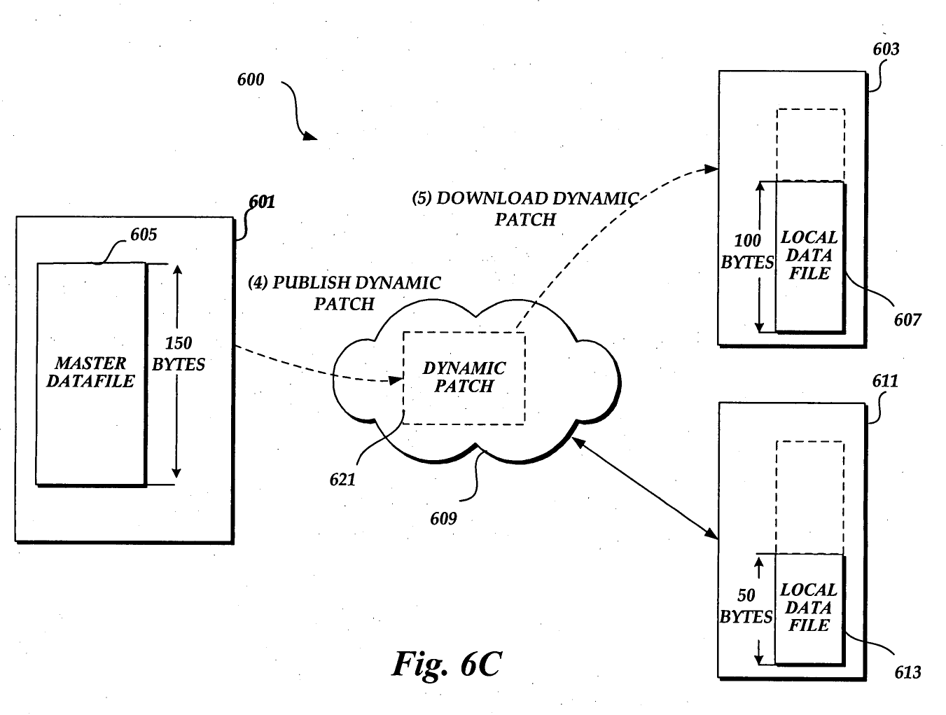

FIGS. 6A-6C are block diagrams illustrative of a computing device network 600 including three computing devices 601, 603, 611. In particular, FIGS. 6A-6C illustrate an example of the overall process for dynamically updating client computing devices 603, 611. As described with respect to the computing devices illustrated in FIG. 5, computing devices 601, 603, 611 may be embodied as any one of a variety of computing devices that may be utilized to interact within computer network 600.

For clarity and ease of description, the discussion provided for FIGS. 6A-6C, 8, and 9 will describe an example for dynamically updating local data file 607 on client computing device 603. A publishing computing device 601 maintains one instance of a master data file 605, and a local computing device 603 maintains one local data file 607. A local data file may be dynamically updated as described in detail below.

In general, the publishing computing device 601 publishes on the network 609 a master data file identifier 615, such as master data file name, and a master data file “unit identifier” 617, as illustrated by FIG. 6A. A “unit identifier” as used herein may be any type of descriptive identifier for a master data file. For example, a unit identifier may be a size of a master data file or a number of digital items included in a master data file (e.g., a number of virus signatures, contacts, spam rules, etc.). The client computing device 603 downloads the published information 615, 617 from the network 609 and utilizing the information, determines what portion, if any, of the master data file 605 it needs in order to update its local data file.

The client computing device 603 communicates with the publishing computing device 601 via the communications network 609 and requests from the publishing computing device 601 the particular “delta” 619 portion of the master data file 605 that the client computing device 603 requires in order to update the local data file 607 (FIG. 6B). A delta, as described herein, is the difference between the published unit identifier and a unit identifier for a local data file. For example, the delta may be a difference in size of the data files that is determined by subtracting the file size of the master data file 605 (published unit identifier 617) from the file size of the local data file 607 (local unit identifier). Alternatively, the delta may be a difference in the number of items included in the data files which is determined by subtracting the number of items in the master data file (published unit identifier 617) and a number of items in the local data file (local unit identifier).

In response to the request for the delta 619, the publishing computing device 603 dynamically generates an appropriate patch and publishes the dynamic patch 621 on the network 609 as illustrated in FIG. 6C. The client computing device 603 downloads the published dynamic patch 621 and regenerates the local data file 607 to match the master data file 605.

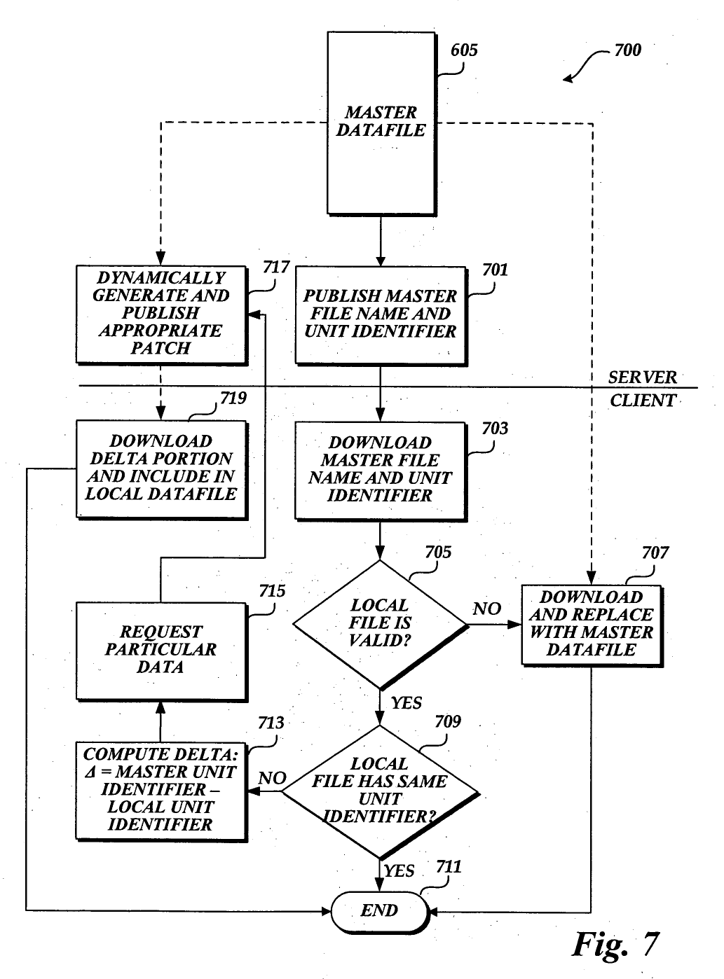

FIG. 7 is a flow diagram illustrative of the overall process 700 utilized by the publishing computing device 601 and a client computing device, such as computing device 603, for dynamically updating a local data file on the client computing device, in accordance with an embodiment of the present invention. As one who is skilled in the art will appreciate, FIGS. 7, 8, and 9 illustrate blocks for performing specific functions. In alternative embodiments, more or fewer blocks may be used. In an embodiment of the present invention, a block may represent a software program, a software object, a software function, a software subroutine, a software method, a software instance, a code fragment, a hardware operation, or a user operation, singly or in combination.

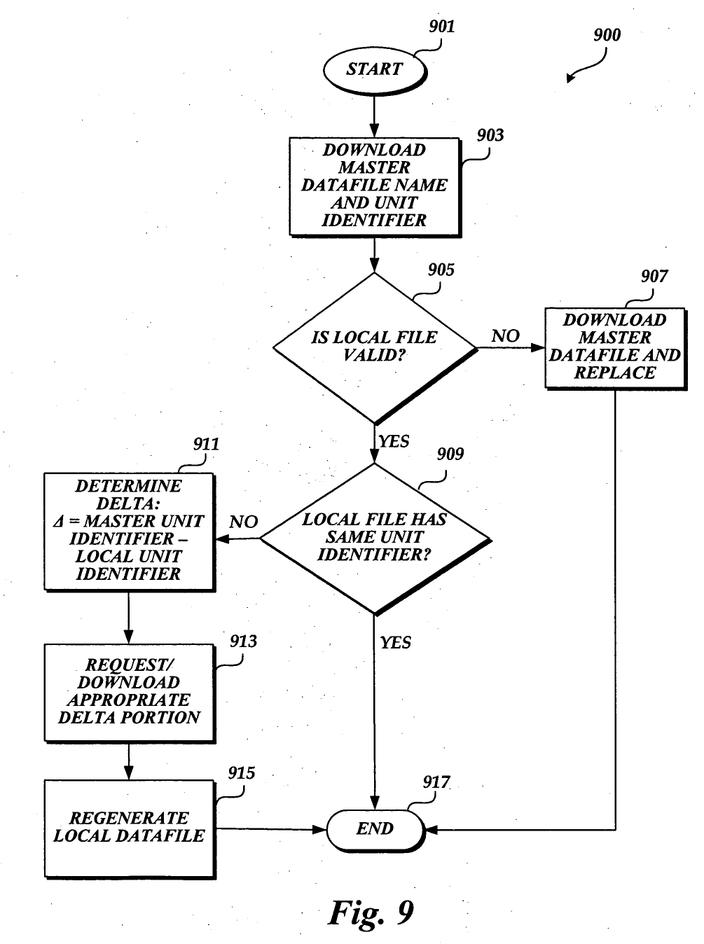

Referring to FIG. 7, at block 701, the publishing (server) computing device 601 publishes a master data file identifier 615 and a master data file unit identifier 617. The client computing device 603, when determining if an update to a local data file 607 is necessary, as illustrated at block 703, downloads the master data file identifier 615 and unit identifier 617 that have been published by the publishing computing device 601. At decision block 705, the client computing device 603 determines if the local data file 607 is valid. The validation process will be described in detail below with respect to FIG. 9.

If it is determined at decision block 705 that the local data file 607 is invalid, at block 707 the client computing device 603 downloads, via the network 609, a full copy of the master data file 605 and replaces the invalid local data file 607 on the client computing device 603. However, if it is determined at decision block 705 that the local data file 607 is valid, at decision block 709 a determination is made by the client computing device 603 as to whether the local data file 607 has the same unit identifier as the unit identifier 617 published at block 701. If the local data file 607 unit identifier is the same as the published unit identifier 617, the process completes, as illustrated by block 711. In an alternative embodiment, the publishing computing device 601 may publish a hash value for the master data file 605, in addition to publishing a unit identifier. The client computing device 603 may use the published hash value to determine whether the local data file 607 has the same hash value as the master data file 605. If the hash values match, the process completes, as illustrated by block 711. If the hash values do not match, the process continues as described below.

At block 713, if it is determined at block 709 that unit identifiers do not match (and/or the hash values do not match), the local computing device 603 computes a delta between the two files. Once the local computing device 603 has determined the delta, at block 715 local computing device 603 requests from the publishing computing device 601 the particular delta 619 of the master data file 605 that is desired. The publishing computing device 601 dynamically generates and publishes an appropriate patch 621 in response to the received delta 619, as illustrated by block 717. Finally, at block 719 the local computing device 603 downloads the dynamically generated patch 621 and recreates the local data file 607 to match the master data file 605.

In one embodiment, the portion of the master data file 605 contained in the dynamic patch 621 that is downloaded by the local computing device 603 is a “tail” portion of the master data file 605. A “tail,” as used herein, is digital information that has been added to the data file subsequent to the last update of the local data file 607. Referring back to FIG. 6A, if the unit identifier 617 is a size, and if the size of the master data file 605 published at block 701 is one hundred fifty bytes and the size of the local data file 607 is one hundred bytes, the computed delta at block 713 is fifty bytes. The fifty bytes would be the “tail” portion of the master data file 605.

The “tail” of a data file can be different for each download and is not limited to one particular portion of the data file. For example, if another client computing device, such as client computing device 611, requested one hundred bytes of the master data file 605, those one hundred bytes would also be considered the “tail” of the master data file 605. Still further, if the unit identifier 617 is a number of items (e.g., number of virus signatures) of digital information contained in the data files, and the published unit identifier 617 is five hundred two and the number of items in the local data file 607 is three hundred two, the computed delta is two hundred. The two hundred items would be the tail portion of the master data file 605.

Upon receiving a request 619 from the client computing device 607, the publishing computing device 601 dynamically generates an appropriate patch 621 for download by the client computing device 603. The patch 621 is dynamic in that it is generated in response to the requested information 619. For example, local data file 607, located on client computing device 603, is one hundred bytes. The requested delta 619 is computed at fifty bytes and thus, the dynamically generated patch 621 includes a copy of the tail fifty bytes of the master data file 605. In contrast, local file 613, located on client computing device 611, is fifty bytes. The requested delta 619 is computed at one hundred bytes and in response to that request, the dynamically generated patch 621 includes a copy of the tail one hundred bytes of the master data file 605.

The client computing device 603 downloads the dynamically generated patch 621 and regenerates the local data file 607 so that it matches the master data file 605. For example, if the patch 621 contains a tail of the master data file 605, the client computing device 603 appends the tail to the local data file 607.

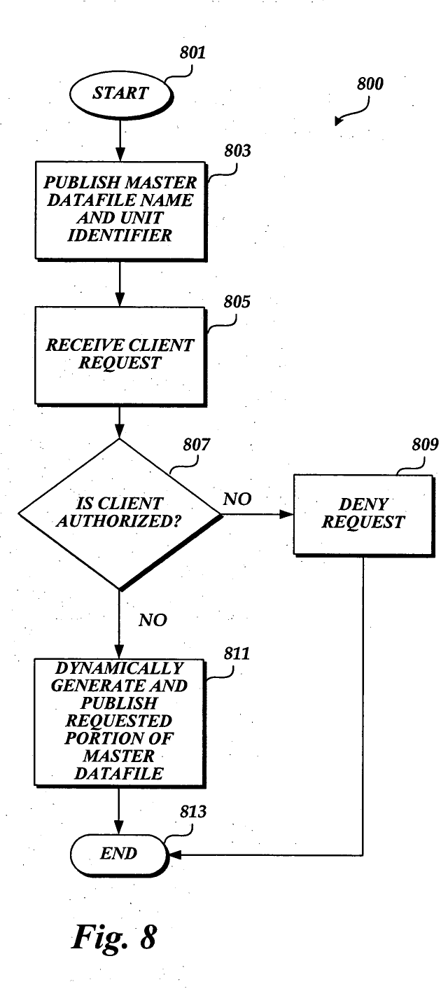

FIG. 8 is a flow diagram illustrative of publish computer software update routine 800 implemented by the publishing computing device 601 illustrated in FIG. 6, in accordance with an embodiment of the present invention. FIG. 8 provides a more detailed discussion of the routine performed by the publishing computing device 601 in completing its portion of dynamic software update routine 700 as described with respect to FIG. 7, in accordance with an embodiment of the present invention.

The publish computer software update routine 800 begins at block 801. At block 803, the publishing computing device 601 publishes a master data file identifier 615 and a unit identifier 617. In an embodiment, the published information 615, 617 may be provided in the form of digital packet containing a digital signature identifying from where the packet is being published. The digital signature may contain a private key which is authenticated by a client containing a public key, thereby validating the sending party. Additionally, the published information 615, 617 may also include a hash value for master data file 605. The information published at block 803 is available for download by the client computing device 603 via network 609.

At block 805, the publishing computing device 601 receives a request 619 from the client computing device 603 via network 609 for a particular portion of the master data file 605. This request may be a request for a tail of the master data file 605-for example, the last 50 bytes of the master data file 605. Alternatively, the client request 619 received at block 805 may include a request for particular portions of the master data file 605. Still further, the request may be a request for an entire copy of the master data file 605.

At decision block 807, the publishing computing device 601 determines if requesting client computing device 603 is authorized to receive the requested information. As will be appreciated by one skilled in the art, authorization of the requesting client computing device 603 may be accomplished using any authorization technique. For example, the client computing device 603 may be required to provide a user name and password that is known to the publishing computing device 601. Alternatively, the client computing device 603 may be required to provide a serial number or other identification for the local data file 607, to thereby authenticate that the client computing device 603 is a legal owner of the local data file 607.

If it is determined at decision block 807 that the requesting client computing device 603 is not authorized to receive the requested information, the requesting client computing device 603, as illustrated by block 809, is denied its request to receive information. If however, it is determined at decision block 807 that the requesting computing device 603 is authorized to receive the requested information, at block 811, the publishing computing device 601 dynamically generates an appropriate patch 621 and provides the dynamically generated patch 621 to the client computing device 603 via the network 609. The dynamically generated patch 621 includes information from the master data file 605 that is necessary for requesting the client computing device 603 to regenerate the local data file 607 to match the master data file 605. Additionally, the dynamically generated patch 621 may also include a digital signature identifying the publishing computing device 601.

Still further, the contents of the dynamically generated patch 621 may also be compressed to shorten the time necessary to download the information. In one example of a patch 621 containing virus signature updates, each virus signature may be individually compressed and added to other compressed virus signatures to create the dynamic patch 621. Such a patch 621, in addition to containing individually compressed virus signatures, may also contain a digital signature that is, or is not compressed.

Once the dynamically generated patch 621 has been published for download by the client computing device 603 the process completes, as illustrated by block 813.

FIG. 9 is a flow diagram illustrative of a receive computer software update routine 900 implemented by a local computing device 603, in accordance with an embodiment of the present invention. FIG. 9 provides a more detailed discussion of the routine performed by the client computing device 603 in completing its portion of the dynamic software update routine 700, in accordance with an embodiment of the present invention.

The receive computer software update routine 900 begins at block 901 where the local computing device 603 initiates communication with the publishing computing device 601 via the network 609, to determine if the local data file 607 needs to be updated to match the master data file 605. At block 903, the local computing device 603 downloads the published master data file identifier 615, unit identifier 617, and any other information that was published by the publishing computing device 601.

At decision block 905, the client computing device 603 determines whether the local data file 607 is valid. Validation of the local data file 607 may be accomplished by comparing a digital signature present on the local data file 607 with a digital signature included with the information published at block 903. The downloaded digital signature may be a private key that is included with every item of information published by the publishing computing device 601 to verify and authenticate that the contents of the information being downloaded are indeed being published by the publishing computing device 601. The client computing device 603 contains a digital signature that is included within the local data file 607. In an embodiment, the digital signature contained in the local data file 607 may be a public key that is used to authenticate the private key downloaded at block 903. When the local data file 607 is initially obtained or created, a digital signature identifying the publishing computing device 601 may be included in the local data file 607. For example, a digital signature may be included in the last five bytes of local data file 607. Each time information is obtained from the publishing computing device 601, a digital signature identifying the publishing computing device 601 may be included. The client computing device 603 may use those two digital signatures to validate the local data file 607, the publishing computing device 601, and the published information. It will be appreciated by those skilled in the art that any other type of validation technique may be utilized for validating the integrity of a local data file. For example, the client computing device 603 may compare the name of the local data file 603 with the name published by the publishing computing device 601.

If it is determined at decision block 905 that the local data file 603 is not valid—for example, because the digital signatures do not match, as illustrated by block 907—the local computing device 603 requests and downloads an entire copy of the master data file 605 from the publishing computing device 601 and replaces the local data file 607 with the downloaded master data file.

If the local data file 603 is valid, at decision block 909 the local computing device 603 determines whether the local data file 607 has the same unit identifier as the master data file unit identifier 617 downloaded at block 903. If it is determined that the unit identifiers match, thereby confirming that the local computing device 603 has the most recent copy of the master data file 605, the process completes, as illustrated by block 917. If however, it is determined that unit identifiers differ, the local computing device 603, as illustrated at block 911, determines the delta between the master data file 605 and the local data file 607.

As illustrated by block 913, the local computing device 603 requests from the publishing computing device 601 a particular delta portion 619 of the master data file 605 that the local computing device 603 needs in order to regenerate a copy of the master data file 605. For example, if the delta 619 between the master data file 605 and the local data file 607 is fifty bytes, the local computing device 603 informs the publishing computing device 601 that it needs the tail fifty bytes of the master data file 605. The local computing device 603 downloads a dynamic patch 621 containing a copy of the appropriate requested portion of the master data file 605 from the publishing computing device 601 via the communication network 609, as illustrated by block 913.

Upon receipt of the dynamically generated patch 621, the local computing device 603, in one embodiment, again validates the integrity of the local data file 607 and the integrity of the downloaded information by comparing the digital signature contained on the local data file 607 and the digital signature included in the dynamically generated patch 621 downloaded from the publishing computing device 601. As illustrated at block 915, the local computing device 603 regenerates the local data file 607 utilizing the information in the downloaded patch to generate a local data file 607 that matches the master data file 605. For example, if the patch 621 is a tail of the master data file 605, the local computing device 603 appends the tail to the end of the local data file 607.

Additionally, after digital signature verification and during regeneration of the local data file 607, the local computing device 603 may copy over the digital signature contained in the local data file 607 and append the downloaded digital signature to the end of the new local data file 607. After the local data file 607 has been regenerated to match the master data file 605, the process completes at block 917.

While embodiments of the invention have been illustrated and described, it will be appreciated that various changes can be made therein without departing from the spirit and scope of the invention.

1. A method for dynamically generating and providing a patch to a computing device, the method comprising:
providing a data file identifier identifying a data file;
providing a unit identifier representative of the data file;
in response to receiving a request for a tail portion of the data file, dynamically generating a patch including a copy of the requested tail portion of the data file; and
providing the dynamically generated patch to the computing device.

2. The method as recited in claim 1, further comprising:
authenticating that a user submitting the request is authorized to receive the dynamically generated patch.

3. The method as recited in claim 1, wherein the data file includes a virus signature.

4. The method as recited in claim 1, wherein the copy of the requested tail portion of the data file includes a virus signature.

5. The method as recited in claim 4, wherein the virus signature is compressed.

6. The method as recited in claim 1, wherein the copy of the requested portion of the data file includes a plurality of virus signatures, and wherein dynamically generating a patch includes, individually compressing at least two of the plurality of virus signatures.

7. The method as recited in claim 6, wherein dynamically generating a patch includes, including a digital signature, and wherein the digital signature is not compressed.

8. The method as recited in claim 1, wherein the data file identifier is a name of the data file.

9. The method as recited in claim 1, wherein the unit identifier is a size of the data file.

10. The method as recited in claim 1, wherein the unit identifier is a number of virus signatures included in the data file.

11. The method as recited in claim 1, wherein the request for a tail portion of the data file includes a request for a number of virus signatures.

12. The method as recited in claim 1, wherein dynamically generating a patch includes, including in the dynamically generated patch a digital signature.

13. The method as recited in claim 12, wherein the digital signature is a private key digital signature.

14. The method as recited in claim 1, wherein the requested tail portion of the data file is a request for the entire data file.

15. The method as recited in claim 1, wherein the data file is a hash value representative of the data file.

16. In a computer network having a plurality of computing devices in communication, a method for updating a local data file, the method comprising:
obtaining a data file identifier identifying a master data file;
obtaining a unit identifier representative of the master data file;
determining a delta between the master data file and the local data file;
obtaining a patch including a copy of a portion of the master data file representative of the determined delta; and
updating the local data file with the obtained copy of the delta portion of the master data file.

17. The method as recited in claim 16, further comprising:
determining if the local data file is valid.

18. The method as recited in claim 17, wherein determining if the local data file is valid includes comparing the obtained data file identifier with a local data file identifier.

19. The method as recited in claim 18, wherein the obtained data file identifier is a first data file name and the local data file identifier is a second data file name; and
wherein determining if the local data file is valid includes, comparing the first data file name and the second data file name and confirming that the first data file name and the second data file name match.

20. The method as recited in claim 18, further comprising:
obtaining a digital signature; and
wherein determining if the local data file is valid includes verifying that the obtained digital signature matches a local digital signature.

21. The method as recited in claim 16, wherein obtaining a patch includes:
sending a request for a delta portion of the master data file equal to the difference in a size of the master data file and a size of the local data file; and
downloading the requested delta portion of the master data file.

22. The method as recited in claim 16, wherein updating the local data file includes regenerating the local data file to include the downloaded delta portion of the master data file.

23. The method as recited in claim 16, wherein subsequent to updating the local data file, the local data file matches the master data file.

24. The method as recited in claim 16, wherein updating the local data file includes decompressing the obtained patch.

25. The method as recited in claim 16, wherein the obtained copy of the portion of the master data file includes a virus signature.

26. In a computer system having a computer-readable medium having a computer-executable program therein for performing the method of dynamically generating and providing data file updates through a network, the method comprising:
publishing on the network an identifier and a size of a data file;
receiving from a source on the network a request for a portion of the data file;
determining if the source is authorized to receive the requested portion of the data file;
dynamically generating an appropriate data file update in response to the request; and
providing to the source the dynamically generated data file update.

27. The method as recited in claim 26, wherein the request for a portion of the data file is a request for all of the data file.

28. The method as recited in claim 26, wherein the data file includes a plurality of virus signatures.

29. The method as recited in claim 26, wherein the dynamically generated data file update includes a digital signature.

30. In a computer system having a computer-readable medium having a computer-executable program therein for performing the method of validating a local data file and updating the local data file, the method comprising:
receiving a first transmission of information, the first transmission of information including a master data file identifier, a unit identifier, and a digital signature;
validating the local data file with the received digital signature;
determining a delta difference between the received unit identifier and a local data file unit identifier;
requesting a delta portion of the master data file representative of the determined delta;
receiving a second transmission of information in response to the request, the second transmission of information including a copy of the requested delta portion of the master data file; and
regenerating the local data file in response to the received second transmission.

31. The computer system of claim 30, wherein the local data file includes a local digital signature; and
wherein validating the local data file includes comparing the local digital signature and the received digital signature and confirming a match.

32. The computer system of claim 31, wherein the local digital signature is a public key and the received digital signature is a private key; and
wherein comparing the local digital signature and the received digital signature includes authenticating the private key with the public key.

33. The computer system of claim 31, wherein the requested delta portion of the master data file received in the second transmission includes a virus signature.

34. The computer system of claim 33, wherein the virus signature is compressed.

35. The computer system of claim 31, wherein the requested delta portion of the master data file received in the second transmission includes a plurality of virus signatures; and
wherein each of the plurality of virus signatures are individually compressed.

36. The computer system of claim 31, wherein the requested delta portion of the master data file received in the second transmission includes a second digital signature.

37. The computer system of claim 36, wherein the local data file includes a local digital signature; and
wherein regenerating the local data file includes replacing the local digital signature with the second digital signature.
